(19) United States
(12) Patent Application Publication
(10) Pub. No.: US 2003/0096527 A1
(43) Pub. Date: May 22, 2003

(54) Connector position assurance apparatus, methods and articles of manufacture

(75) Inventor: Robert D. Greiner, Jamestown, NC (US)

Correspondence Address: Joseph A. Tessari, Esquire, Tyco Technology Resources, 4550 New Linden Hill Road, Suite 450, Wilmington, DE, 19808-2952, US

(73) Assignee: TYCO ELECTRONICS CORP., Middletown, PA

(21) Appl. No.: 09/991,719

(22) Filed: Nov. 21, 2001

(51) Int. Cl. H01R 13/627

(52) U.S. Cl. 439/352

(57) ABSTRACT

Connector position assurance apparatus, methods and articles of manufacture are disclosed. The preferred embodiments comprise a connector position assurance mechanism mounted upon a plug assembly component. The connector position assurance mechanism provides a relatively fixed connection to a mounting latch which is used to ensure connection between the plug assembly and a header assembly.

### FIELD OF THE INVENTION

This invention relates to apparatus, methods and articles of manufacture for electrical connectors. More particularly, this invention relates to apparatus, methods and articles of manufacture for electrical connectors, comprised of mating housings, for vehicles and the like.

### BACKGROUND OF THE INVENTION

Electrical connectors for vehicles and the like are often comprised of separate housings that are engaged through pressure, or “snap fit,” upon installation. Snap fit connectors are desirable because of the ease of installation. However, in order to ensure proper installation various complexities must be taken into account.

For example, the housings must be must be securely fastened so they do not come apart after installation. Additionally, they must properly aligned so that an electrical connection is made upon installation.

In order to attempt to resolve these and other difficulties, various mechanisms have been used. One especially desirable mechanism is a connector position assurance (CPA) mechanism. CPA mechanisms, placed externally to the housings, are used to assure locking and/or positioning of connector housings.

Use of a CPA may lead to further difficulties when designing a connector. An external CPA may increase the space required for the connector, so a CPA may be unavailable for a connector to be mounted in a tight space. Accordingly, it would be beneficial to have a small, effectively integrated CPA mechanism for use in electrical connectors.

Therefore, it is an object of the present invention to provide an electrical connector with integrated CPA.

It is a further object of the present invention to provide an electrical connector with integrated CPA that minimally increases the size of the connector.

It is yet a further object of the present invention to provide a small, lightweight electrical connector with integrated CPA.

### SUMMARY OF THE INVENTION

The present invention comprises connector position assurance apparatus, methods and articles of manufacture. The preferred embodiments are used with connectors that have a rear housing and front housing wherein the two are assembled together to form an mechanical and electrical connection. The connector position assurance mechanism of the preferred embodiments is mounted at least partially upon the rear housing and slides to a predetermined locking position so as to lock a mating latch used to connect the rear housing to a front housing. Audible and tactile feedback assure the connector position assurance mechanism has reached its predetermined locking position.

### BRIEF DESCRIPTION OF THE DRAWINGS

FIG. 1 shows a plan view of a preferred embodiment.

FIG. 2 shows a plan view of a preferred embodiment.

FIG. 3 shows a plan view of a preferred embodiment.

FIG. 4 shows a plan view of a preferred embodiment.

FIG. 5 shows a plan view of a preferred embodiment.

### DETAILED DESCRIPTION OF THE PREFERRED EMBODIMENTS

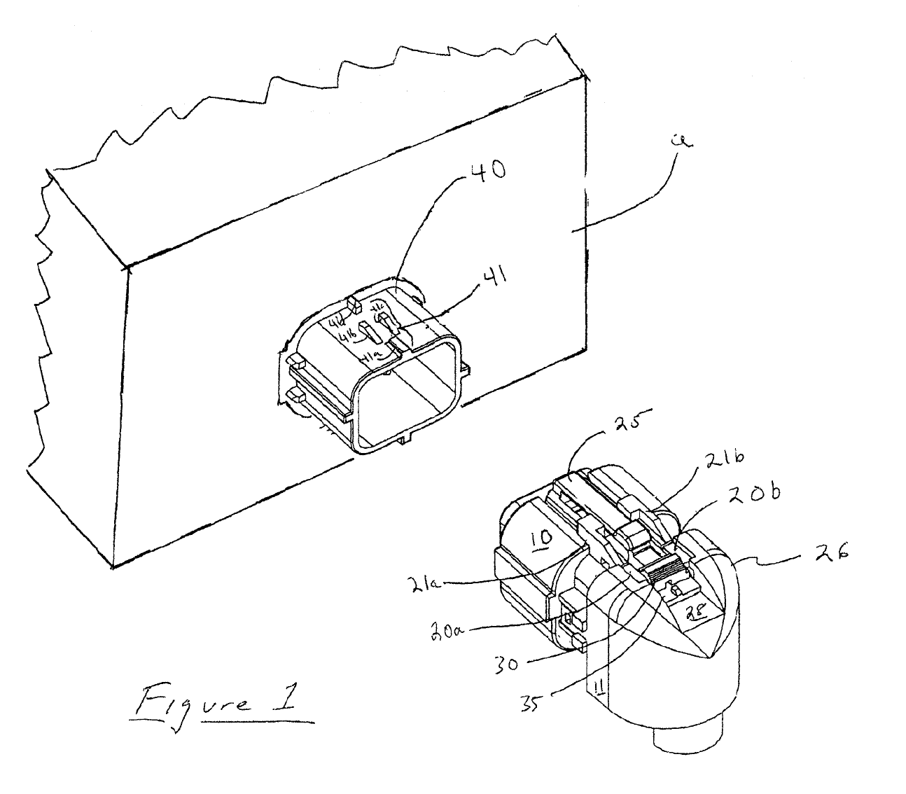

FIG. 1 shows a preferred embodiment of the present invention as it might be mounted upon support surface a. Header assembly 40 is mounted upon support surface a through a mounting base on the inside of the support surface (not shown) through screws or other mounting means as known in the art. Present within header assembly 40 are a plurality of male contacts (not shown) that engage with respective female contacts (not shown) when plug assembly 10 is installed, as will be further described. Mating latch engagement means 41, comprised of mating latch engagement lugs 41a, 41b, 41c and 41d, are provided on header assembly 40. These engagement means will provide positive engagement with mating latch 25 when plug assembly 10 is installed, as will be further described below.

It should be noted that header assembly and plug assembly are used herein to denote a first and second connector housing respectively. The first and second housings are to be understood as connector components so that, when properly connected, a desired mechanical and electrical contact is made between the housings.

Returning now to FIG. 1, plug assembly 10 is provided with mating latch 25, which provides an engagement between the assemblies. The plug assembly described herein also comprises a wire seal cover 11, which provides insulation for any wires (or other electrical conduit as known in the art) provided. Other embodiments may be used on plug assemblies, also known herein as second connector housings, that do not use a wire seal cover, or use other wire protection and/or insulation mechanisms as are known in the art. The various components of the embodiments are made from materials as known in the art, such as for example, 15% Glass PBT for the CPA tab, and possibly, the housings.

The electrical conduit shown here is also provided with wire dress cover 26. Also shown is recess 28, and lugs 20a, 20b, 21a and 21b, which have mounted therein connector position assurance (CPA) tab 30 and CPA base 35, as will be further described below. CPA tab 30 is, in this Figure, in mated position, thus providing position assurance support to mating latch 25 and so locking the assemblies. However, in installed position, and as will be further described below, under normal use the CPA tab 30 will remain in unmated position until header assembly 40 and plug assembly 10 are connected. Of course, in other embodiments, the CPA might be placed in mating position before housing connection.

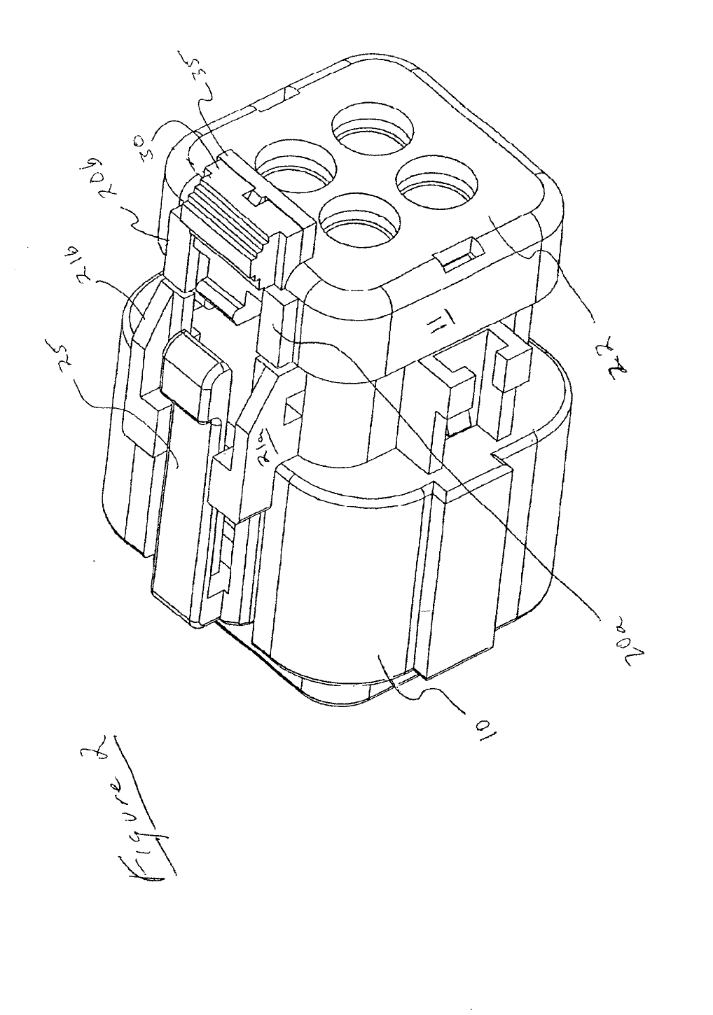

Turning to FIG. 2, a view of the plug assembly 10 and wire seal cover 11, without a wire dress cover, is seen. Face plate 22 comprises openings for female contacts on a wire harness to engage male contacts on a header assembly, as had been described above. Of course, in other embodiments other contacts as known in the art may be used, such as, for example, providing female contacts on a header assembly with corresponding male contacts on a plug assembly; interlocking contacts on corresponding housings; etc.

Extending upwardly from wire seal cover 11 are lugs 20a and 20b and extending upwardly from plug assembly 10 are lugs 21a and 21b. Connector position assurance (CPA) tab 30 is slideably mounted within lugs 20a, 20b, 21a and 21b, and upon CPA base 35, as will be further described below.

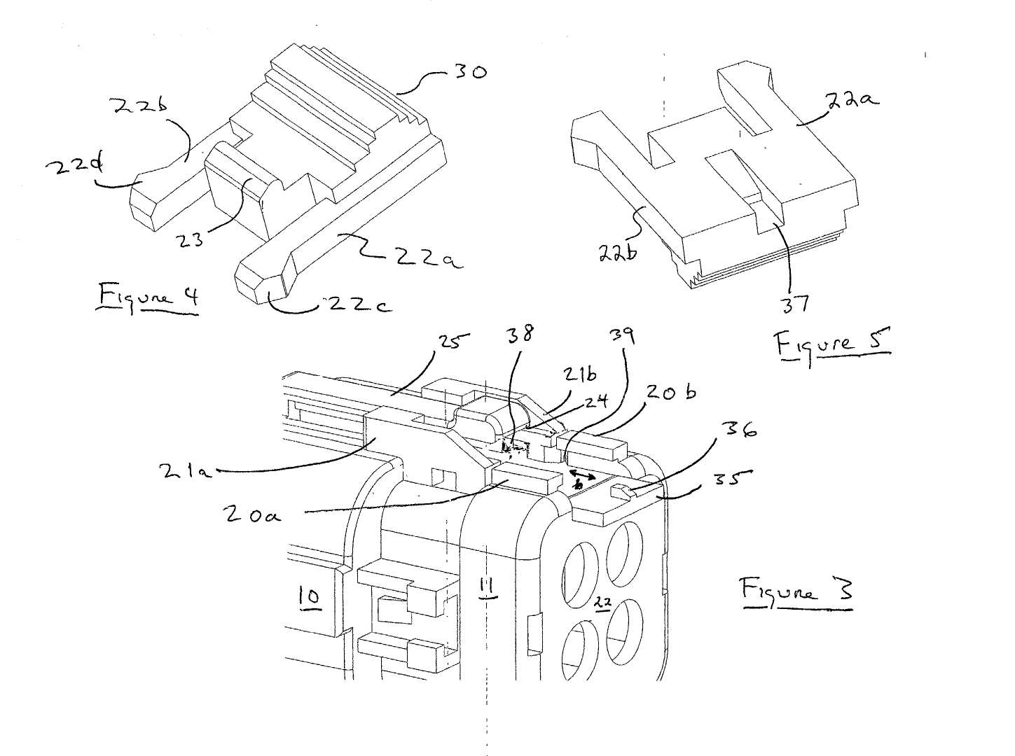

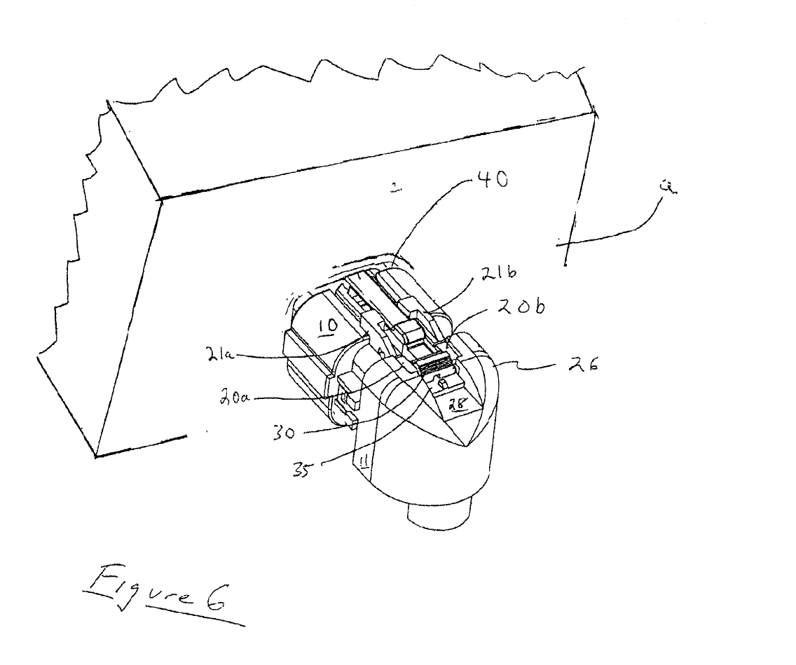

FIG. 3 shows a view of the embodiment of FIGS. 1 and 2 with the CPA tab removed. In ordinary use, the tab remains installed on the plug assembly and wire seal cover in this embodiment, but is removed here. Lug 36 comprises a stop, preventing backward movement of the CPA tab when installed. The direction of movement of the CPA tab is shown by arrow b, along CPA base 36 as retained by lugs 20a, 20b, 21a and 21b, as will be further described below. To assist in assuring movement of the CPA tab only when desired, lug 22d of the CPA tab (shown in FIG. 4) rests in recess 39 when the CPA tab is unmated. A corresponding recess not shown here, will engage lug 22c (also shown in FIG. 4.) When desired, CPA tab is moved into mating position, and lug 22d will be moved out of recess 39 and into recess 38. A similar lug—recess engagement will occur with regard to lug 22c and a recess not shown here. The engagement of lug 22c and 22d in their respective recesses, and concomitant CPA tab mating will be confirmed by an auditory and tactile click feedback in this embodiments. Other embodiments may use other feedback, or none at all, to confirm CPA tab mating. It should be noted that the preferred embodiments use a relatively fixed connection between the connector position assurance and mounting latch means.

The CPA tab of the embodiment of FIG. 3 is shown in FIGS. 4 and 5. Legs 22a and 22b engage lugs 20a, 20b, 21a and 21b as the tab is being slid along base 35 (shown in FIG. 3) for connector positioning. As had been described above, when the connector is properly positioned, lugs 22c and 22d are mated with corresponding recesses.

FIG. 5 shows recess 37, which engages lug 36 shown in FIG. 3 to prevent reverse movement (or disengagement from the plug assembly and wire seal cover) of the CPA tab.

Returning now to FIG. 2, CPA tab 30 is shown in an unmated position, that is, disengaged from mating latch 25.

FIG. 6 shows the embodiment of FIG. 1 in connected position, with header assembly 40 connected to plug assembly 25. Mating latch 25 has been slid over lugs 41a-41c. CPA tab 30 has been slid to a mated position. Thus, CPA surface 23 (shown in FIG. 4) engages with mating latch surface 24 (shown in FIG. 3) and lugs 22c and 22d (not shown here—see FIGS. 4 and 5) have engaged with corresponding recesses as had been described above. This mating of CPA tab prevents matching latch 25 from moving off latch engagement lugs 41a, 41b, 41c and so provides locking for the header and plug assemblies.

It should be noted that, in this embodiment, the mating of CPA tab 30 will usually occur in a two step process. First, the plug assembly is connected to the header assembly and the mating latch 25 engages latch engagement lugs 41a, 41b and 41c. Then, CPA tab 30 is slid forward to contact with mating latch 25 as described above, and provides audible and tactile feedback to ensure proper positioning. Thus the CPA serves to lock the plug assembly to the header assembly.

The above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

I claim:

1. An apparatus for connecting electrical components comprising:
a first component, comprising a header assembly;
a second component, comprising a plug assembly, for connecting to said first component;
a connector position assurance means;
a mounting latch means for connecting said first and second housing means;
a mounting means, at least partially contained on said plug assembly, for said connector position assurance means;
whereby said connector position assurance means is slideably mounted with mounting means and, as said first and second components are connected through said mounting latch means, said connector position assurance means engages said mounting latch means in order to provide a locking connection between said first and second components.

2. An apparatus as in claim 1 wherein said connector position assurance means further comprises a displaceable lug means.

3. An apparatus as in claim 1 further comprising an engagement means for engagement with said mounting latch means upon connection of said first and second components.

4. An apparatus as in claim 3 wherein said engagement means is mounted on said first component.

5. An apparatus as in claim 1 wherein said mounting latch means is mounted on said second component.

6. An apparatus as in claim 2 wherein said connector position assurance means is engaged with said mounting latch means through said displaceable lug means.

7. A method for connecting electrical components comprising:
lockably connecting a first component, comprising a header assembly to a second component, comprising a plug assembly, for connecting to said first component, through a connector position assurance means engaging a mounting latch means.

8. A method as in claim 7 wherein the step of lockably connecting further comprises placing said connector position assurance means into a relatively fixed arrangement with said mounting latch means in order to provide a locking connection between said first and second components.

9. A method as in claim 7 further comprising providing an engagement means for engagement with said mounting latch means.

10. A method as in claim 9 wherein said connector position assurance means engages said mounting latch means through a displaceable lug means.

11. A method for connecting electrical components comprising:
connecting a header assembly to a plug assembly through a mating latch means, and;
fixing said matching latch means by a connector position assurance means; thereby locking said plug assembly to said header assembly.

12. A method as in claim 11 wherein the step of fixing said matching latch means by a connector position assurance means and thereby locking said plug assembly to said header assembly further comprises the step of receiving audible feedback upon fixing.

13. A method as in claim 11 wherein the step of fixing said matching latch means by a connector position assurance means and thereby locking said plug assembly to said header assembly further comprises the step of receiving tactile feedback upon fixing.

14. An article of manufacture for connecting electrical components comprising a connector position assurance means, configured for mounting upon a plug assembly, which connector position assurance means further comprises at least one displaceable lug means.
